(19) United States
(12) Patent Application Publication
(10) Pub. No.: US 2011/0156680 A1
(43) Pub. Date: Jun. 30, 2011

(54) Methods and related controllers for controlling output power of a power supply

(76) Inventor: Wen-Chung Yeh, Hsin-Chu (TW)

(21) Appl. No.: 12/970,950

(22) Filed: Dec. 17, 2010

(30) Foreign Application Priority Data
Dec. 25, 2009 (TW) 098144984

(51) Int. Cl. G05F 1/00

(52) U.S. Cl. 323/282

(57) ABSTRACT

A method of controlling a power supply comprising a switch and an inductive device includes turning the switch on to energize the inductive device, detecting inductor current flowing through the inductive device to generate a current sensing signal, comparing a peak of the current sensing signal and a limiting signal to generate an adjustment value, and comparing the current sensing signal and the limiting signal. The switch is closed when the current sensing signal, the limiting signal, and the adjustment value are approximately in a specific relationship for approximately equalizing a next peak of the current sensing signal to the limiting signal to cancel signal delay influence.

### BACKGROUND OF THE INVENTION

1. Field of the Invention

The present invention relates to a type of switched-mode power supply (SMPS), and more particularly to an SMPS capable of providing over current protection (OCP) or over load protection (OLP).

2. Description of the Prior Art

Power supplies act as a type of power management device utilized for converting power to provide power to electronic devices or components. Sometimes, power management devices adopt a switched-mode power supply architecture, because energy conversion efficiency of the SMPS architecture is good, and number of required inductive devices is relatively low. The SMPS architecture is applicable to many current-generation electronic devices or components. An SMPS requires multiple protection mechanisms for preventing damage caused by internal or external events that may arise from inaccurate or inappropriate conditions. Over voltage protection (OVP), over temperature protection (OTP), over current protection (OCP), and over load protection (OLP) are some of a few types of protection mechanisms employed in power supplies. OCP is typically concerned with limiting maximum output current; OLP is typically concerned with limiting maximum output power.

FIG. 1 illustrates a type of booster having OCP/OLP. Booster 10 is only utilized as one example of OCP/OLP. OCP/OLP may also be utilized in other SMPS architectures.

Switch 14 of booster 10 controls current flowing through inductor 12. When gate signal GATE turns on switch 14, energy stored on inductor 12 increases. When gate signal GATE turns off switch 14, energy stored on inductor 12 is released into a load through diode 16 to charge load capacitor 20. Sense resistor 22 detects inductor current flowing through inductor 12 while switch 14 conducts (is on). Voltage level of current sensing signal V_{CS} at terminal CS reflects inductor current magnitude, based on which controller 18 generates gate signal GATE.

FIG. 2 illustrates a type of controller 18a suitable for use with booster 10 of FIG. 1. When controller 18a turns on switch 14 of FIG. 1, voltage level of current sensing signal V_{CS} increases with turn on time. Comparator 36 controls peak value of current sensing signal V_{CS} to be approximately less than limiting signal V_{CS-LIMIT}. Comparator 36 causes gate controller 34 to turnoff switch 14 whenever current sensing signal V_{CS} exceeds limiting signal V_{CS-LIMIT}, thereby achieving OCP/OLP. However, signal propagation delay causes peak value of the current sensing signal V_{CS} to be slightly higher than the limiting signal V_{CS-LIMIT}, and this difference increases with increased voltage level of input voltage supply V_{IN}. If limiting signal V_{CS-LIMIT} is a fixed value, maximum output current or maximum output power limited by the OCP/OLP provided in FIG. 2 changes with voltage level of input voltage supply V_{IN}. This type of result makes it hard for the OCP/OLP to meet system specifications.

Even if peak value of the current sensing signal V_{CS} is held to a fixed value, maximum output current/power defined by OCP/OLP will be different if inductor 12 is operated in continuous conduction mode (CCM) or discontinuous conduction mode (DCM).

Thus, OCP/OLP circuit requires special design, so that maximum output current/power approximates a fixed value when triggered, and does not change with conduction mode or input voltage supply voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a type of booster having OCP/OLP.

FIG. 2 illustrates a type of controller suitable for use with booster of FIG. 1.

FIG. 3 is a graph illustrating relationship between V_{CS-PEAK} and V_{CS-AVG} of equation (3).

FIG. 4 is a diagram illustrating controller that may be utilized with booster of FIG. 1 according to an embodiment

FIG. 5A and FIG. 5B illustrate two types of signal delay compensator that may be utilized with FIG. 4.

FIG. 6 illustrates average current comparator, modifier, and clamp, which may be utilized with FIG. 4.

FIG. 7 illustrates relationship of limiting signal VCS-LIMIT and expected average inductor current signal VCS-AVG-EXP, and simplification result thereof.

FIG. 8 illustrates a converter for use in controller of FIG. 4.

FIG. 9 illustrates a controller according to an embodiment

FIG. 10 illustrates one example of a peak value detector.

FIG. 11 illustrates simplified relationship of VCS-PEAK and VCS-AVG.

FIG. 12 illustrates a converter for realizing relationship in FIG. 11, and usable in FIG. 9.

### DETAILED DESCRIPTION

In the following description, similar reference numerals refer to same or similar devices/components. A person of ordinary skill in the art may make embodiments utilizing same or similar methods/architectures according to disclosure/teaching of the present invention, so repeated description is not provided.

An embodiment provides an SMPS, of which when OCP/OLP is triggered, maximum output current/power is independent of input voltage and conduction modes.

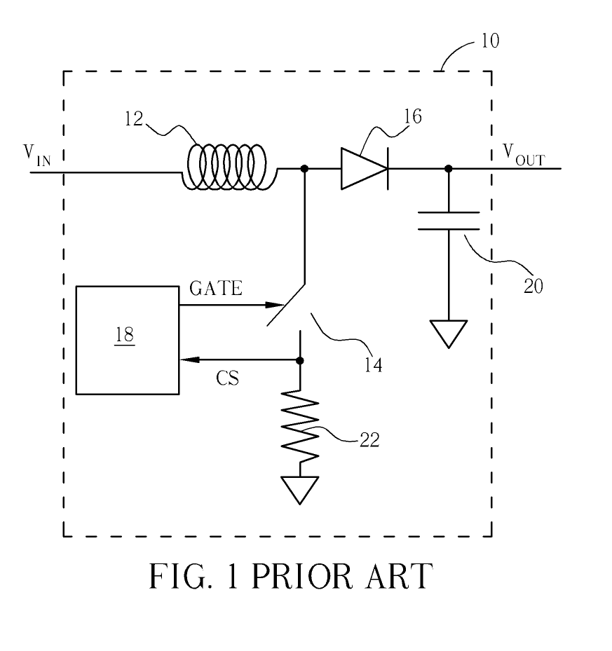

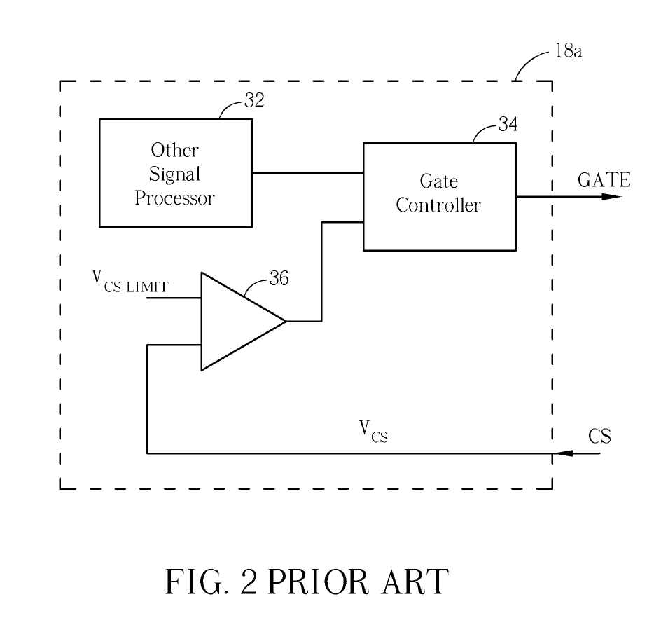

Please refer to booster 10 of FIG. 1. Power P transferred to load capacitor 20 by inductor 12 may be expressed as follows:

P=½*L*(I²_{CS-PEAK}−I²_{CS-INI})*f_{SW} (1)

where L represents inductance of inductor 12, I_{CS-PEAK} represents peak value of inductor current flowing through inductor 12 (which is also peak value of current flowing through switch 14), I_{CS-INI} represents initial inductor current flowing through inductor 12 (which is also initial current flowing through switch 14) each time switch 14 turns on, and f_{SW} represents switching frequency of switch 14. In DCM operation, I_{CS-INI} is 0 Amps; in CCM operation, I_{CS-INI} is greater than 0 Amps.

The right half of equation (1) should be a fixed value because maximum output power P_{OLP} is a fixed value when OLP is triggered. The right half of equation (1) should be a fixed value for OCP as well, because maximum output current C_{OCP} is a fixed value when OCP is triggered, assuming output voltage V_{OUT} is kept at a fixed voltage level.

Assuming switching frequency f_{SW} of booster 10 does not change, a part in equation (1), when OLP/OCP is triggered, can be rewritten as:

I²_{CS-PEAK}−I²_{CS-INI}=4*I_{CS-AVG}*(I_{CS-PEAK}−I_{CS-AVG})=K₁ (2)

where I_{CS-AVG} represents ½*(I_{CS-PEAK}+I_{CS-INI}), which may also represent average inductor current flowing through switch 14 when switch 14 is turned on; K₁ is a constant, too.

Equation (2) may be rewritten as follows:

V_{CS-PEAK}=V_{CS-AVG}+K/V_{CS-AVG} (3)

where K is a constant, V_{CS-PEAK} and V_{CS-AVG} represent voltage levels of current sensing signal V_{CS} corresponding to inductor currents I_{CS-PEAK} and I_{CS-AVG}, respectively. When OCP/OLP occurs, as long as V_{CS-PEAK} and V_{CS-AVG} meet the requirement of equation (3), maximum output current/power defined by OCP/OLP approximates a fixed value.

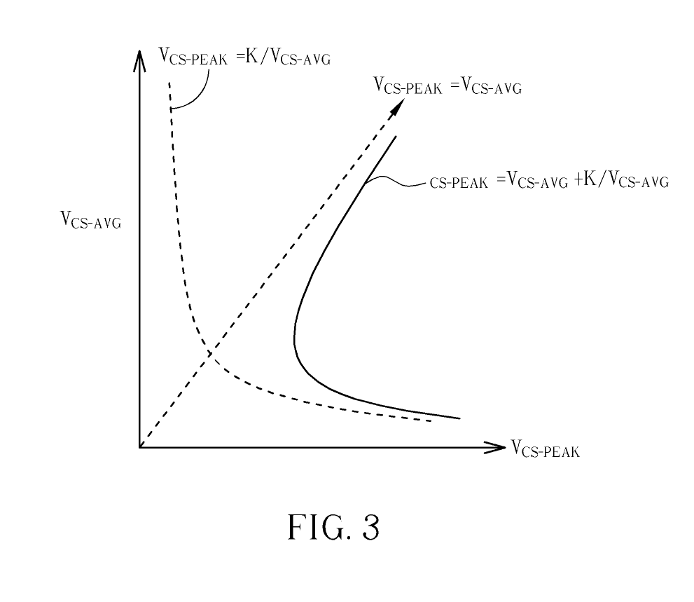

FIG. 3 is a graph illustrating relationship between V_{CS-PEAK} and V_{CS-AVG} of equation (3). Two dashed lines represent V_{CS-PEAK}=V_{CS-AVG} and V_{CS-PEAK}=K/V_{CS-AVG}, respectively. For example, if booster 10 is designed to operate in DCM, V_{CS-PEAK} of 0.9 Volts should trigger OCP/OLP, meaning V_{CS-AVG} is 0.45 Volts, and K should be 0.45*0.45 Volts². Solid curve of FIG. 3 represents relationship between V_{CS-PEAK} and V_{CS-AVG} when OCP/OLP is triggered.

Thus, as long as V_{CS-PEAK} and V_{CS-AVG} of any switching cycle are known, and are substituted into equation (3) for calculation, it may be determined whether output current/power is greater or less than maximum output current/power defined by OCP/OLP, thereby updating limiting signal V_{CS-LIMIT}. After a few switching cycles, output current/power of every switching cycle will be approximately a fixed value, which is maximum output current/power defined by OCP/OLP.

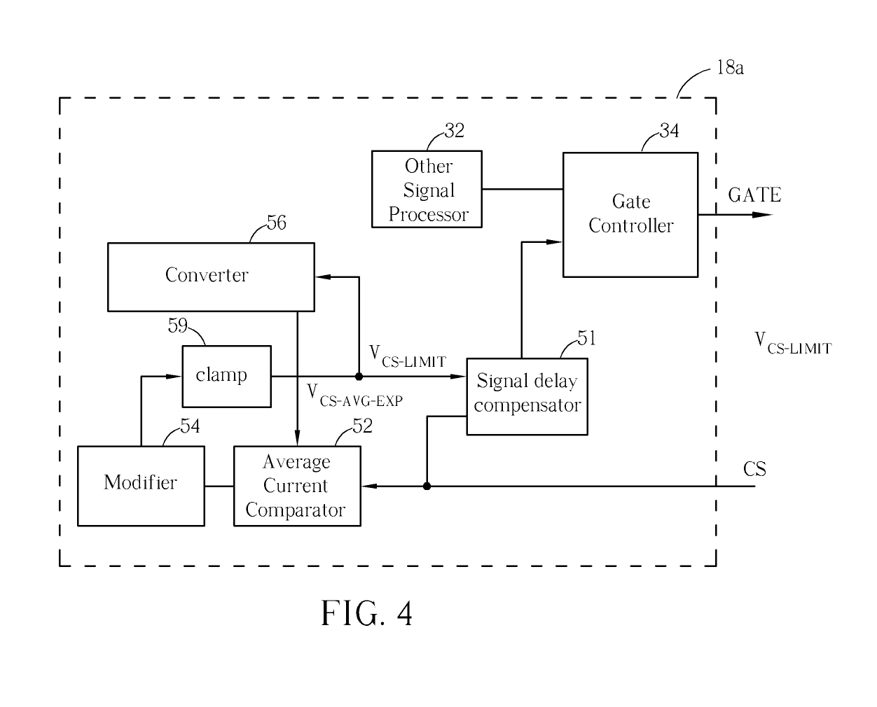

FIG. 4 is a diagram illustrating controller 18b that may be utilized with booster 10 of FIG. 1 according to an embodiment, and may be utilized with other types of SMPS. Gate controller 34 receives signals from other signal processor 32 and signal delay compensator 51 for driving switch 14. Signal delay compensator 51 may approximately compensate signal delay effect, making peak value V_{CS-PEAK} of current sensing signal V_{CS} almost equal to limiting signal V_{CS-LIMIT}. Thus, limiting signal V_{CS-LIMIT} may be seen as peak value V_{CS-PEAK} of current sensing signal in any switching cycle. Converter 56 approximately takes limiting signal V_{CS-LIMIT} as an input, and outputs expected average inductor current signal V_{CS-AVG-EXP} according to relationship between V_{CS-PEAK} and V_{CS-AVG} (which may be obtained through simplification of solid line in FIG. 3). Average current comparator 52 compares average current V_{CS-AVG-REAL} (which is the average of V_{CS} when switch 14 is turned on) and expected average inductor current signal V_{CS-AVG-EXP}. Output of average current comparator 52 causes modifier 54 to modify limiting signal V_{CS-LIMIT}. Clamp 59 is utilized for limiting maximum and minimum of limiting signal V_{CS-LIMIT}.

It can be seen from FIG. 4 that converter 56, average current comparator 52, and modifier 54 substantially form a closed loop. After multiple switching cycles, relationship between V_{CS-PEAK} and V_{CS-AVG} approaches solid line of FIG. 3 or a corresponding segment thereof, such that operation of the loop causes maximum output current/power defined by OCP/OLP to become a fixed value.

Signal delay compensator 51, converter 56, and average current comparator 52, and modifier 54 may be seen as a regulator that modifies limiting signal V_{CS-LIMIT} to cause peak value V_{CS-PEAK} and average current V_{CS-AVG-REAL} corresponding to current sensing signal V_{CS-LIMIT} to approach predetermined relationship in FIG. 3 with progression of switching cycles.

For example, when expected average inductor current signal V_{CS-AVG-EXP} is lower than average current V_{CS-AVG-REAL}, limiting signal V_{CS-LIMIT} increases in the next switching cycle. Thus, expected average inductor current signal V_{CS-AVG-EXP} approaches average current V_{CS-AVG-REAL} in the next switching cycle.

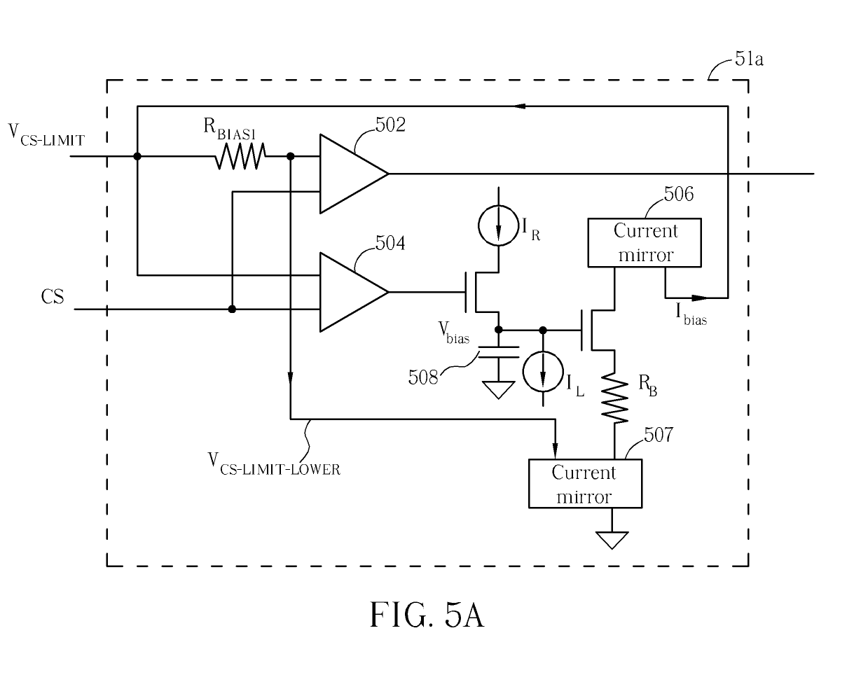

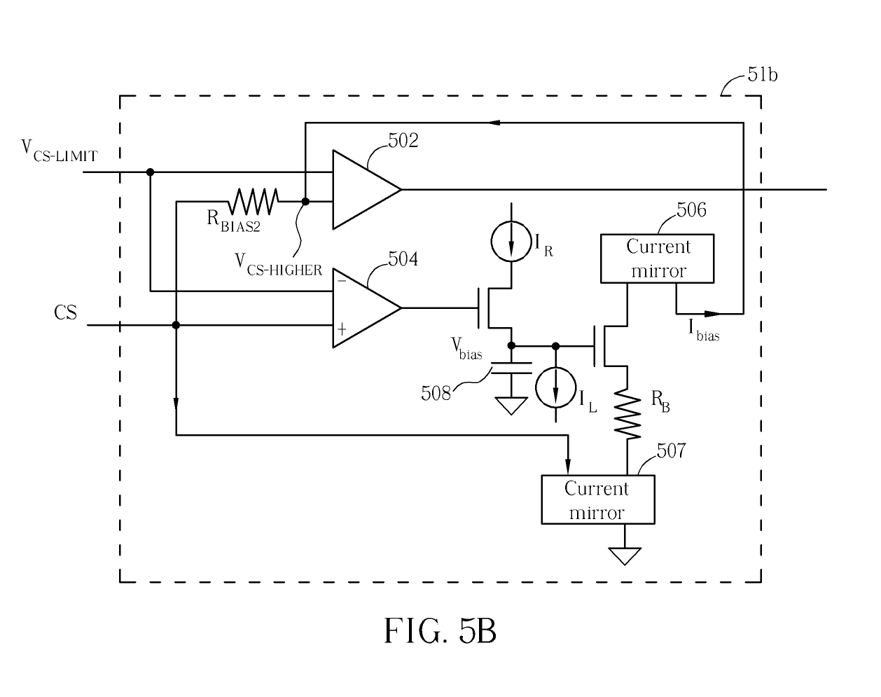

FIG. 5A and FIG. 5B illustrate two types of signal delay compensator 51A and 51b that may be utilized with FIG. 4. In FIG. 5A, signal delay compensator 51a primarily comprises comparators 502, 504, capacitor 508, current sources I_{R}, I_{L}, and resistors R_{B}, R_{BIAS1}. If peak value V_{CS-PEAK} of current sensing signal V_{CS} is greater than limiting signal V_{CS-LIMIT} comparator 504 causes current source I_{R} to charge capacitor 508 and pull up capacitor voltage V_{bias}. If peak value V_{CS-PEAK} of current sensing signal V_{CS} is less than limiting signal V_{CS-LIMIT} current source I_{L} slowly discharges capacitor 508 and pull down capacitor voltage V_{bias}. Current source I_{L} must be much smaller than current source I_{R}. Voltage V_{BIAS1} is generated across resistor R_{BIAS1} as capacitor voltage V_{bias} is converted into current I_{bias} through resistor R_{B} and current mirrors 506, 507, thereby providing a lower limiting signal V_{CS-LIMIT-LOWER} lower than limiting signal V_{CS-LIMIT}. Output signal of comparator 502 turns off switch 14 when current sensing signal V_{CS} is greater than lower limiting signal V_{CS-LIMIT-LOWER}. After multiple switching cycles, capacitor voltage V_{bias} is held at approximately a fixed value, making comparator 502 early send signal when current sensing signal V_{CS} equals lower limiting signal V_{CS-LIMIT-LOWER} finally causing peak value V_{CS-PEAK} of current sensing signal V_{CS} to equal limiting signal V_{CS-LIMIT}. Current source I_{L} may be optional if self-leakage of capacitor 508, or junction leakage, is utilized to pull down capacitor voltage V_{bias} slowly.

Signal delay compensator 51b of FIG. 5B may also cause peak value V_{CS-PEAK} of current sensing signal V_{CS} to equal limiting signal V_{CS-LIMIT}. Different from generation of lower limiting signal V_{CS-LIMIT-LOWER} in FIG. 5A, FIG. 5B shows generating higher current sensing signal V_{CS-HIGHER}. Other circuit architecture and operating principles of FIG. 5B are same or similar to FIG. 5A, and can be derived from FIG. 5A by persons skilled in the art.

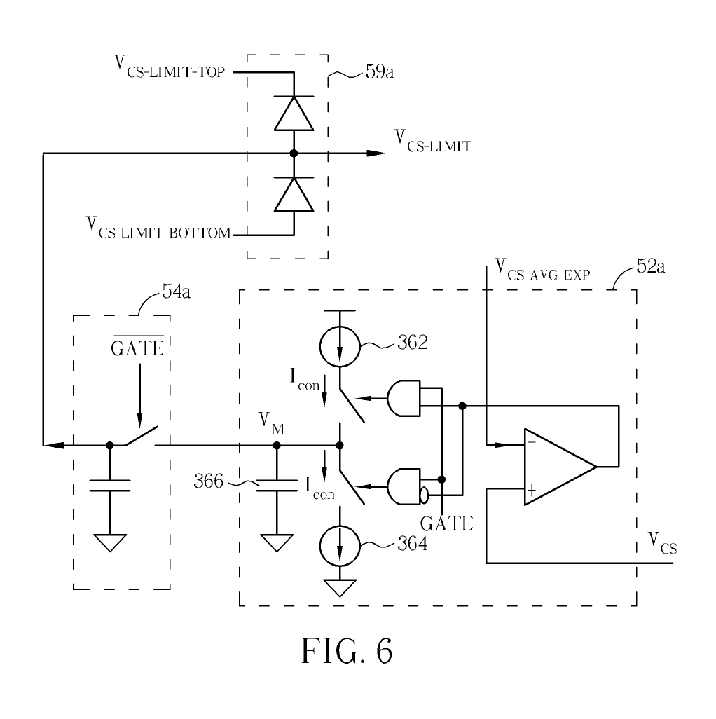

FIG. 6 illustrates average current comparator 52a, modifier 54a, and clamp 59a, which may be utilized with FIG. 4.

It can be seen from variation in output voltage V_{M} of average current comparator 52a whether average current V_{CS-AVG-REAL} (average of current sensing signal V_{CS}) is greater than or less than expected average inductor current signal V_{CS-AVG-EXP}. Current source 362 provides fixed current I_{con} to charge capacitor 366 when current sensing signal V_{CS} is greater than expected average inductor current signal V_{CS-AVG-EXP}. Current source 364 provides fixed current I_{con} to discharge capacitor 366 when current sensing signal V_{CS} is less than expected average inductor current signal V_{CS-AVG-EXP}. Current sensing signal V_{CS} increases linearly, so output voltage V_{M} increases if average current V_{CS-AVG-REAL} is greater than expected average inductor current signal V_{CS-AVG-EXP} when gate signal GATE causes switch 14 to turn on. Output voltage V_{M} decreases if average current V_{CS-AVG-REAL} is relatively small.

Modifier 54a updates limiting signal V_{CS-LIMIT} according to output voltage V_{M} when gate-bar signal G̅A̅T̅E̅ causes switch 14 to turn off. To prevent over voltage or under voltage, clamp 59a utilizes two diodes to force voltage level of limiting signal V_{CS-LIMIT} between top limit V_{CS-LIMIT-TOP} and bottom limit V_{CS-LIMIT-BOTTOM}.

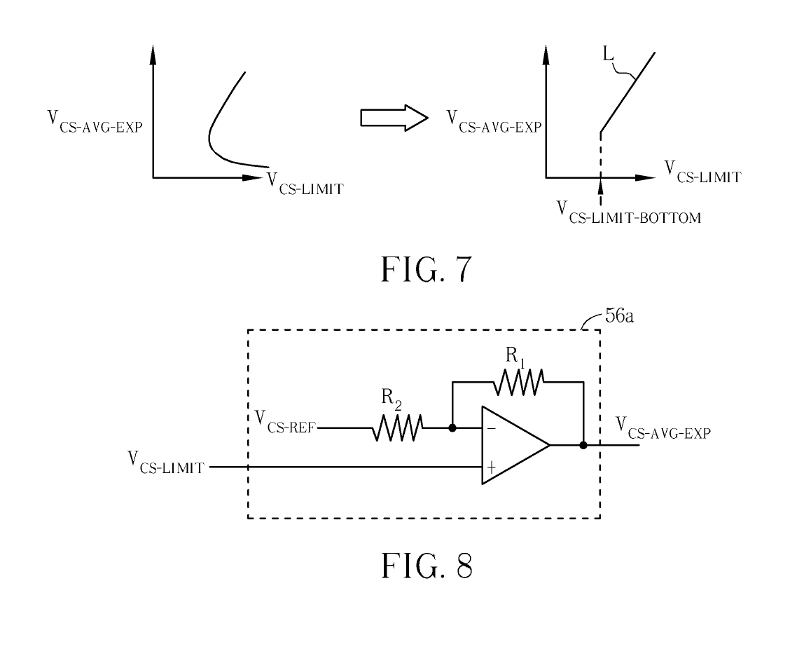

FIG. 7 illustrates, in the left side, the relationship of limiting signal V_{CS-LIMIT} and expected average inductor current signal V_{CS-AVG-EXP}, namely the relationship of V_{CS-PEAK} and V_{CS-AVG} of FIG. 3; and, in the right side, a simplification result thereof. The relationship of V_{CS-PEAK} and V_{CS-AVG} in FIG. 3 is a curve, circuit implementation of which may be relatively complicated. Thus, the curve in FIG. 3 may be represented as a single line segment or a piecewise linear curve. A signal straight line is a simplest method for representing upper half of the curve, as shown by line L in the right side of FIG. 7. Lower half of the curve may be omitted, as such conditions do not arise in practical operation. Line L in FIG. 7 (right) may be realized by multiple different types of circuits. For example, as shown in FIG. 8, a simple operational amplifier together with resistors R₁ and R₂ may realize line L, acting as a converter 56a for use in controller 18b of FIG. 4.

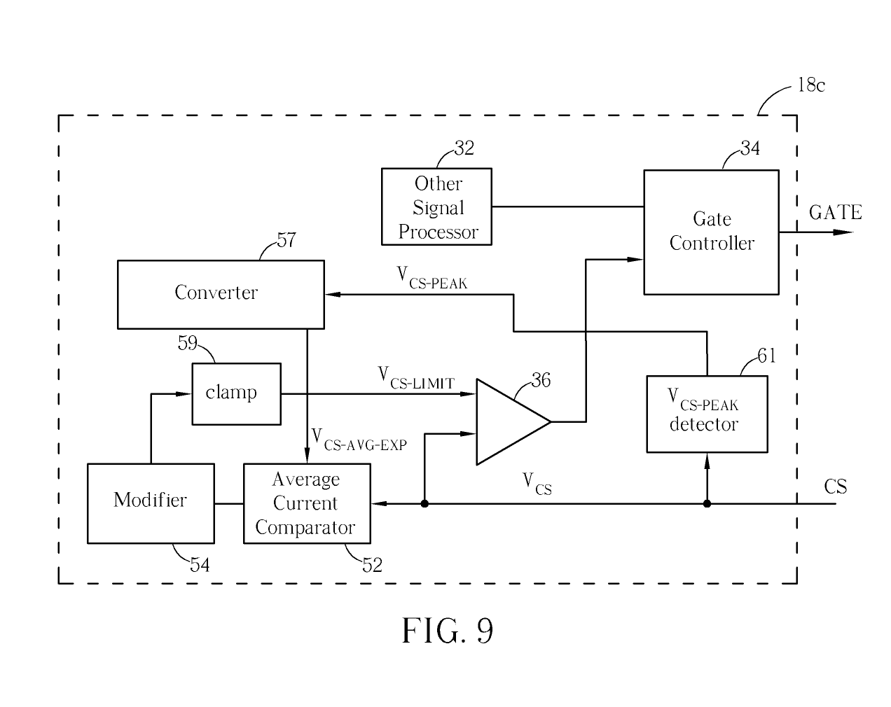

FIG. 9 illustrates a controller 18c according to an embodiment, which may be utilized with booster 10 of FIG. 1, and is suitable for use with other types of SMPS.

FIG. 9 does not include signal delay compensator 51 of FIG. 4, utilizing only comparator 36 to replace signal delay compensator 51 so as to expect peak value V_{CS-PEAK} of current sensing signal VCS not to be greater than limiting signal V_{CS-LIMIT}. As described above, due to signal delay, such an architecture causes peak value V_{CS-PEAK} to approach but exceed limiting signal V_{CS-LIMIT}. In FIG. 9, peak value detector 61 is utilized for detecting peak value V_{CS-PEAK}. Converter 57 takes peak value V_{CS-PEAK} as input, and outputs expected average inductor current signal V_{CS-AVG-EXP} roughly based on relationship between V_{CS-PEAK} and V_{CS-AVG} (which could be obtained from the simplification of solid curve in FIG. 3).

FIG. 9 also includes a closed loop, substantially formed by peak value detector 61, converter 57, average current comparator 52, modifier 54, comparator 36, gate controller 34, switch 14, and sense resistor 22. After multiple switching cycles, relationship between V_{CS-PEAK} and V_{CS-AVG} approaches solid line or a corresponding segment thereof in FIG. 3, such that operation of the loop causes maximum output current/power defined by OCP/OLP to become a fixed value.

Peak value detector 61, converter 57, and average current comparator 52, and modifier 54 can be seen as another adjusting module for adjusting limiting signal V_{CS-LIMIT} to cause peak value V_{CS-PEAK} and average current V_{CS-AVG-REAL} corresponding to current sensing signal V_{CS} to approach predetermined relationship in FIG. 3 along with progression of switching cycles.

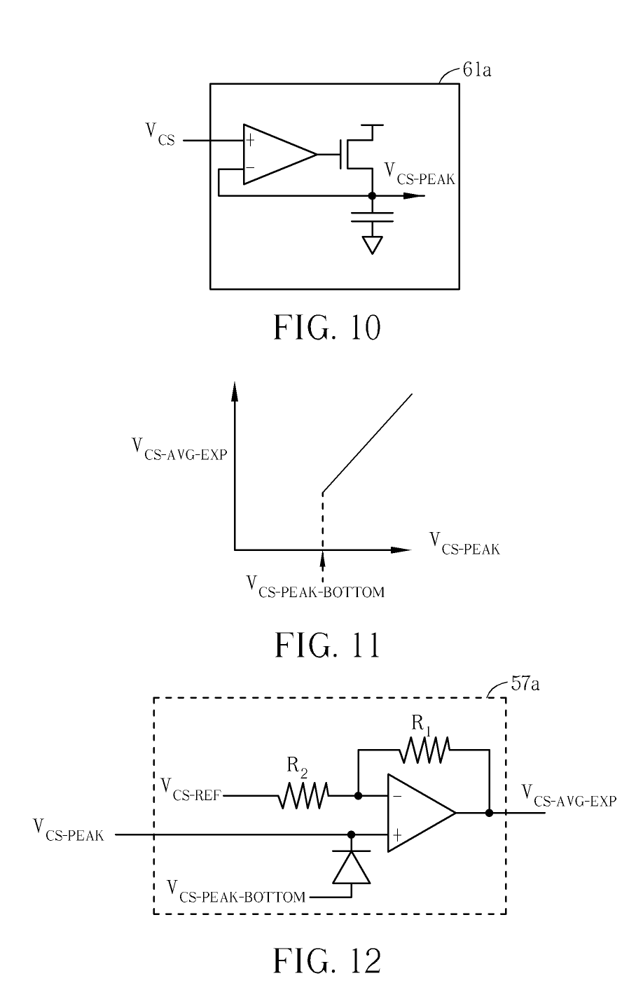

FIG. 10 illustrates one example of a peak value detector 61a. A capacitor thereof may store peak value V_{CS-PEAK}. FIG. 11 illustrates simplified relationship of V_{CS-PEAK} and V_{CS-AVG} for causing maximum output current/power defined by OCP/OLP to become a fixed value. FIG. 12 illustrates a converter 57a for realizing relationship in FIG. 11, and usable in FIG. 9.

Those skilled in the art will readily observe that numerous modifications and alterations of the device and method may be made while retaining the teachings of the invention.

What is claimed is:

1. A method of controlling a power supply comprising a switch and an inductive device, the method comprising:
turning the switch on to energize the inductive device;
detecting inductor current flowing through the inductive device to generate a current sensing signal;
comparing a peak of the current sensing signal and a limiting signal to generate an adjustment value; and
comparing the current sensing signal and the limiting signal, and closing the switch when the current sensing signal, the limiting signal, and the adjustment value are approximately in a specific relationship for approximately equalizing a subsequent peak of the current sensing signal to the limiting signal, thereby cancelling signal delay influence.

2. The method of claim 1, further comprising:
a first current charging a capacitor when the peak of the current sensing signal is greater than the limiting signal;
a second current discharging the capacitor when the peak of the current sensing signal is less than the limiting signal, wherein the second current is smaller than the first current; and
converting the voltage of the capacitor to the adjustment value.

3. The method of claim 1, further comprising:
reducing the limiting signal by the adjustment value to generate a reduced limiting signal; and
comparing the current sensing signal and the reduced limiting signal, and closing the switch when the current sensing signal is greater than or equal to the reduced limiting signal.

4. The method of claim 1, further comprising:
increasing the current sensing signal by the adjustment value to generate an increased current sensing signal; and
comparing the increased current sensing signal and the limiting signal, and closing the switch when the increased current limiting signal is greater than or equal to the limiting signal.

5. A method of controlling a power supply comprising a switch and an inductive device, the method comprising:
turning on the switch to energize the inductive device;
detecting inductor current flowing through the inductive device to generate a current sensing signal;
providing a limiting signal for limiting a peak of the inductor current; and
updating the limiting signal according to the peak and an average inductor current corresponding to the current sensing signal for controlling the peak and the average inductor current to approach a predetermined relationship with a switching period thereby controlling output power outputted by the power supply over one switching period to approximate a fixed value.

6. The method of claim 5, further comprising:
equalizing the peak of the current sensing signal with the limiting signal; and
updating the limiting signal according to the current sensing signal and the limiting signal.

7. The method of claim 6, further comprising:
generating an expected average inductor current signal according to the limiting signal; and
updating the limiting signal according to the expected average inductor current signal and the current sensing signal.

8. The method of claim 5, further comprising:
recording the peak of the current sensing signal;
generating an expected average inductor current signal according to the peak; and
updating the limiting signal according to the expected average inductor current signal and the current sensing signal.

9. A method of controlling a power supply comprising a switch and an inductive device, the method comprising:
turning on the switch to energize the inductive device;
detecting inductor current flowing through the inductive device to generate a current sensing signal;
providing a limiting signal for limiting a peak of the inductor current; and
providing a closed feedback loop controlling the limiting signal for forcing the peak and an average inductor current corresponding to the current sensing signal to approach a predetermined relationship thereby controlling power transmitted by the inductive device over a switching period to approximate a fixed value.

10. A controller for controlling a power supply comprising a switch and an inductive device, the controller comprising:
a peak limiter receiving a limiting signal and a current sensing signal for limiting a peak of an inductor current flowing through the inductive device, wherein the current sensing signal corresponds to the inductor current; and
an adjusting module for updating the limiting signal to control the peak and an average inductor current corresponding to the current sensing signal to approach a predetermined relationship as switching cycles progress thereby keeping power transmitted by the inductive device over a switching period approximately constant.

11. The controller of claim 10, wherein the peak limiter comprises a comparator having two input terminals for receiving the limiting signal and the current sensing signal, and the adjusting module comprises a peak detector for recording the peak of the inductor current.

12. The controller of claim 10, wherein the peak limiter comprises a signal delay compensator having two input terminals for receiving the limiting signal and the current sensing signal, for equalizing the peak to the limiting signal.

13. The controller of claim 10, wherein the adjusting module comprises an average current comparator for comparing the average inductor current corresponding to the current sensing signal with an expected average inductor current signal.
